(19) United States
(12) Patent Application Publication
(10) Pub. No.: US 2006/0222742 A1
(43) Pub. Date: Oct. 5, 2006

(54) Bread paper container

(76) Inventor: Shoji Komatsu, Tokyo (JP)

Correspondence Address: RABIN & BERDO, P.C., Suite 500, 1101 14th Street, N.W., Washington, DC, 20005, US

(21) Appl. No.: 11/391,333

(22) Filed: Mar. 29, 2006

(30) Foreign Application Priority Data
Mar. 31, 2005 (JP) JP2005-128570

(51) Int. Cl. A23B 7/148

(52) U.S. Cl. 426/106

(57) ABSTRACT

It is therefore a primary object of the invention to provide a bread paper container that improves shortcomings of metal can, to apply lighter and safer material, the processes of filling, ferment, toasting etc. is finished in succession in this paper container, no contamination issue during whole process. To apply paper as material of the container, the issues of garbage process and environmental protection also better than the metal can. In order to achieve the objective set forth, a bread paper container in accordance with the present invention applies thermostability paper as material that is lighter than metal, the paper container weight only 1/4 of traditional metal can, no finger cutting issues by metal can.

### BACKGROUND OF THE INVENTION

1. Field of the Invention

This invention relates generally to a paper container and, more specifically, to a bread paper container.

II. Description of the Prior Art

Heretofore, it is known that traditional canned bread are installed inside the metal can, metal can have better airtight nature, bread can be preserved for several years; for general consumers, canned bread preserved for several years are for rescue or special purposes not for daily food. Metal can have many shortcomings that bring inconvenience, such as cutting fingers while opening. Metal can is not a highly safe container. Metal can are heavier that will increase inconvenience and higher cost during transportation; metal material is not a good choice for environment; the disposed metal can cause trouble for consumers and manufacturers.

### SUMMARY OF THE INVENTION

It is therefore a primary object of the invention to provide a bread paper container that improves shortcomings of metal can, to apply lighter and safer material, the processes of filling, ferment, toasting etc. is finished in succession in this paper container, no contamination issue during whole process. To apply paper as material of the container, the issues of garbage process and environmental protection also better than the metal can.

In order to achieve the objective set forth, a bread paper container in accordance with the present invention applies thermostability paper as material that is lighter than metal, the paper container weight only ¼ of traditional metal can, no finger cutting issues by metal can.

Besides the aforesaid, dough is wrapped with resin cellophane, while toasting, butter is prevented from leaking from bottom or sides of the paper container; bread will not stick on paper container after baking; the bottom is in cup shape to prevent leaking. The top of cellophane is folded and pre-cut in “Y” shape to assure the dough can inflate properly during baking, and maintain steady height and size.

The bottom opening of the container is rolled up to be curve flange; the curve lower flange hold the bottom from coming out, dough is placed on the bottom, the bottom is not glued, the toast bread can be pushed up from bottom to take it out.

The heat conductivity of paper is not so good compares to metal, while baking, bread might have different shape and size; an Aluminum board with good conductivity is placed on top of the paper container to solve the issue.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a cross-sectional view of the dough is placed inside a paper container;

FIG. 2 is a top view of the cellophane is unfolded;

FIG. 3 is a side view of the bottom of paper container;

FIG. 4 is a section of the dough is baking in the oven.

### DESCRIPTION OF THE PREFERRED EMBODIMENT

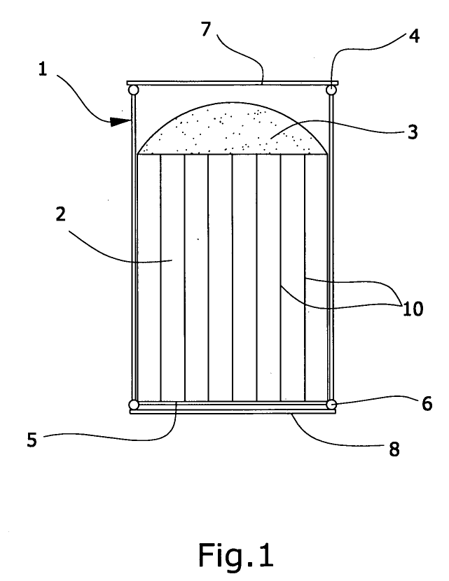

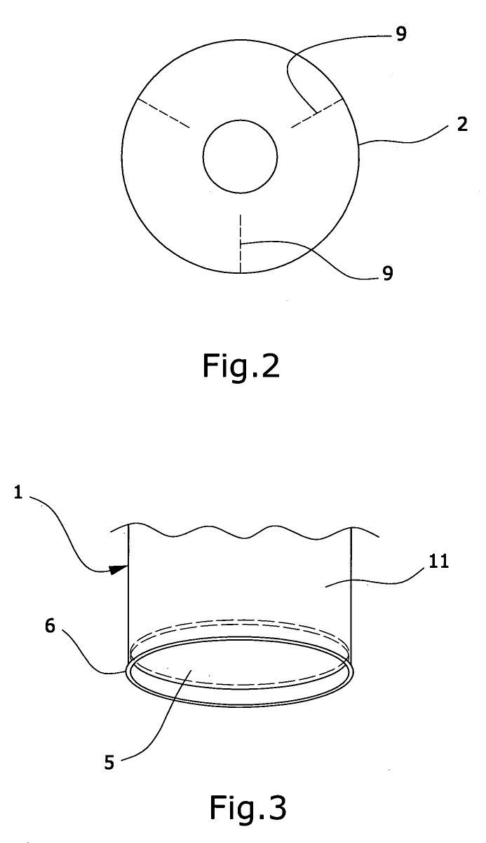

Referring to FIG. 1 to FIG. 4, FIG. 1 shows dough is wrapped in cup shape by a cellophane 2 and placed inside a paper container 1 from top opening. Three pre-cut lines 9 in “Y” shape are on the cellophane 2 (as shown in FIG. 2), and all folded in wave shape 10 (as shown in FIG. 1) that suppress the excessive inflation of bread while baking, further more such can achieve complete toasted and same shape effect.

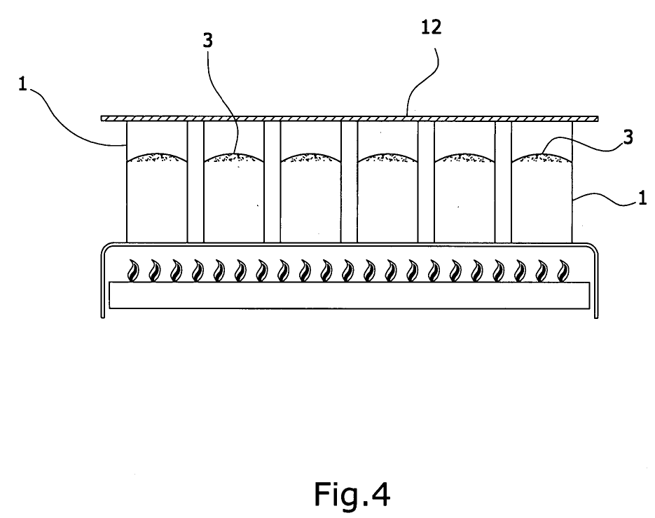

The dough is wrapped in a cup shape cellophane 2, after certain period of time to ferment, the dough along with paper container 1 are placed inside the oven at 190° C. for 12 minutes; a good heat conductivity Aluminum board 12 (as shown in FIG. 4) covers the top of the paper container 1 to keep the toasted bread 3 maintaining steady height and shape.

In order to prevent moisture from evaporation from the toasted bread, a thermofusibe diaphragm 7 is covered on opening of the paper container 1 in seconds, Additionally, in order to easily sealed the openings, the upper edge of the opening is rolled up to curved flange 4 (as shown in FIG. 1) and the thermofusible diaphragm 7 is larger than the upper opening 3 mm. The top of bread is in egg shape and will not touch the inner upper wall of the paper container 1, after the paper container I is open, the bread is easily to take out.

In order to take the bread out easier, as shown in FIG. 3, the present invention adopts separated bottom 5 to hold the bread, the curved flange 6 on the bottom of the paper container 1 such an extent that hold the the bottom 5, users can just push up the bottom with fingers and take the bread out.

Paper container have more ventilative character compare to metal can, the top and bottom of the present invention are sealed with heat dissolve diaphragm; the surface of the body 11 of the paper container 1 is wrapped with packing paper that is daubed with OP NISH which is fadeproof anti-ventilatdive and anti-ultraviolet; the whole package is wrapped with plastic membrane externally again to solve the ventilation issue in the end.

Based on the description above, the material of the present invention is paper, paper is thermostability, can be heated with microwave oven, recyclable and reusable; ferment, toast processes are all done inside the paper container.

The present invention improves the overweight and easy to cut finger shortcoming of metal can; the material is paper that makes the garbage process after application easier, also good to environmental protection.

The paper container weight only ¼ of traditional metal can, loading to transporter is reduced.

Metal can sometimes is dangerous in occasion while a lot of gathering people, such as stadium or concert, metal can are forbidden; the present invention is made of paper, weight is light and safe, people can bring the present invention to above-mentioned occasions.

What is claimed is:

1. A bread paper container comprising:
a round container with dough inside for ferment, the ferment dough with said container is placed into oven to bake for bread, said container do not leak butter, not easy to dry out, the bottom of said container separates from the main body of said container, users take contents easily, the instability heat conductivity of paper is minimized, the inequality of toast bread is also minimized;

2. The bread paper container recited in claim 1, wherein dough is wrapped with resin cellophane, the bottom is in cup shape to prevent leaking from bottom or sides, the top of said cellophane is folded and pre-cut in “Y” shape to assure the dough can inflate properly during baking, and maintain definite height and size;

3. The bread paper container recited in claim 1, wherein the bottom of said paper container is rolled up to curve flange, said curve flange is more beetling than the both sides of body of said container to such an extent that hold the bottom, said bottom does not need any glue to wedge on said container;

4. The bread paper container recited in claim 1, wherein a better heat conductivity Aluminum board covers the top of said paper container to keep the toasted bread maintaining definite height and shape.
